(19) United States
(12) Patent Application Publication
(10) Pub. No.: US 2018/0122609 A1
(43) Pub. Date: May 3, 2018

(54) MAIN SHAFT FOR THE OPERATION MECHANISM OF A CIRCUIT BREAKER

(71) Applicant: General Electric Technology GmbH, Baden (CH)

(72) Inventors: Daniel KALIN, Oberentfelden (CH); Peter VON ALLMEN, Kirchleerau (CH)

(21) Appl. No.: 15/568,052

(22) PCT Filed: Apr. 18, 2016
(86) PCT No.: PCT/EP2016/058507

§ 371 Date: Oct. 20, 2017

(30) Foreign Application Priority Data
Apr. 20, 2015 (EP) 15164328.5

(51) Int. Cl. H01H 71/10

(52) U.S. Cl. CPC H01H 71/10

(57) ABSTRACT

A shaft for an operating mechanism of a circuit breaker, this shaft comprising a splined axle carrying cams intended to cooperate with other parts of the mechanism, this shaft being intended to be carried by ball bearings and to be connected to an actuating member of the circuit breaker to move it. According to the invention, the shaft comprises a cast part comprising the cams and comprising seats for the ball bearings at each of its extremities, this cast part being having at its center a splined hole to receive the splined axle.

### FIELD OF INVENTION

The invention relates to the main shaft of an operation mechanism intended to actuate an indoor or outdoor electric circuit breaker.

### BACKGROUND OF THE INVENTION

The main shaft of an operation mechanism for a circuit breaker is typically mounted into an enclosure with the main shaft protruding out of this enclosure, and being connected to an actuating member or lever of the circuit breaker.

To avoid appearance of an electric arc in the circuit breaker when it is opened, the main shaft has to be rotated quickly and accurately along a predetermined rotational path. More specifically, if the electric contacts are opened at sufficient speed and at the appropriate time, the chances of an electric arc appearing are almost zero.

This kind of operation mechanism typically comprise an actuating spring cooperating with cams and levers carried by secondary shafts, to actuate the main shaft for rotation along the predetermined rotational path. When the circuit breaker is to be opened, the spring is released to rotate the cams and levers carried by the secondary shaft which in turn rotate the main shaft at appropriate speed in order to move the actuating member of the breaker.

With the operation being conducted in a very short time interval, the mechanical components of this mechanism will have to be moved at high speed, requiring that the mechanism be powerful, and that it be carried by a strong frame, as can be seen on FIGS. 4 and 5 of patent document U.S. Pat. No. 7,227,091.

Typically, the main shaft of this kind of mechanism, which can be seen in FIG. 1, comprises a splined axle 2 carrying cams, levers and the like marked as 3, 4, 5, 6, intended to cooperate with other parts of the mechanism.

As seen in FIG. 1, each of the levers 3-6 is made of a flat plate of metal comprising a splined hole at its center, such as the one marked as 8, the splined axle 2 being inserted into this splined hole 8, ensuring that the lever cannot rotate relatively to the axle.

The splined axle 2 of the shaft 1 is carried by ball bearings 9, 10 mounted on supports of the mechanism which are not shown on FIG. 1. One of the extremities of the splined axle 2 protrudes out of the enclosure of the mechanism, so as to be coupled to the actuating member of the circuit breaker.

Upon operation, the shaft rotates at high speed along a predetermined rotational path when it is moved by the actuating spring. As a result, the components of this shaft such as its levers and the interface of each lever with the splined axle that carries it are subjected to significant mechanical stress.

Since this results in high mechanical constraints of torsion and bending applied to the shaft, the splined axle has to be made of a high tensile strength metal. Moreover, the levers need to have a strong connection to the axle in order to withstand the high working torque resulting from the large efforts applied by the spring.

The aim in an embodiment is to find a solution to reduce the production cost of such a shaft.

### BRIEF DESCRIPTION OF THE INVENTION

Embodiments of the invention relate to a shaft for an operating mechanism of a circuit breaker, this shaft comprising a splined axle carrying levers intended to cooperate with other parts of the mechanism, this shaft being intended to be carried by ball bearings and to be connected to an actuating member of the circuit breaker to move it, characterized in that this shaft comprises a cast part comprising the cams and comprising seats for the ball bearings at each of its extremities, this cast part comprising a splined longitudinal central through hole at its center to receive the splined axle.

In an embodiment of the invention, the torque is transmitted directly from the levers to the splined axle, while it is the cast part which withstands most of the bending and torsion stress since it has a very rigid structure and since it is directly carried by the bearings. The resulting shaft has structurally a high resistance against mechanical stress, allowing to use less resistant materials for its production.

An embodiment of the invention also relates to a shaft such as defined above, wherein the cast part comprises a central tubular portion which comprises extremities having cylindrical faces to form the seats for the ball bearings.

An embodiment of the invention also relates to a shaft such as defined above, where the levers comprise a flat body oriented perpendicular to the longitudinal direction of the tubular portion, each flat body surrounding the tubular portion and comprising at least an extremity extending at distance from the tubular portion.

An embodiment if the invention also relates to a cast part for a shaft such as designed above.

### BRIEF DESCRIPTION OF THE DRAWINGS

FIG. 1 is an exploded view in perspective of a shaft of the state of the art;

FIG. 2 is a view in perspective of a cast part of the shaft;

FIG. 3 is a view in perspective of the cast part of the shaft.

### DETAILED DESCRIPTION OF THE INVENTION

The idea behind an embodiment is to provide a single cast part comprising the levers cams and the like, as well as the seats for the bearings, and which can withstand the main part of the mechanical stress and constraint applied to the main shaft by the mechanism during operation. This cast part is hollow at its center to receive a splined axle which protrudes out of the mechanism and out of the housing of this mechanism to have an extremity connected to the operating member of the circuit breaker.

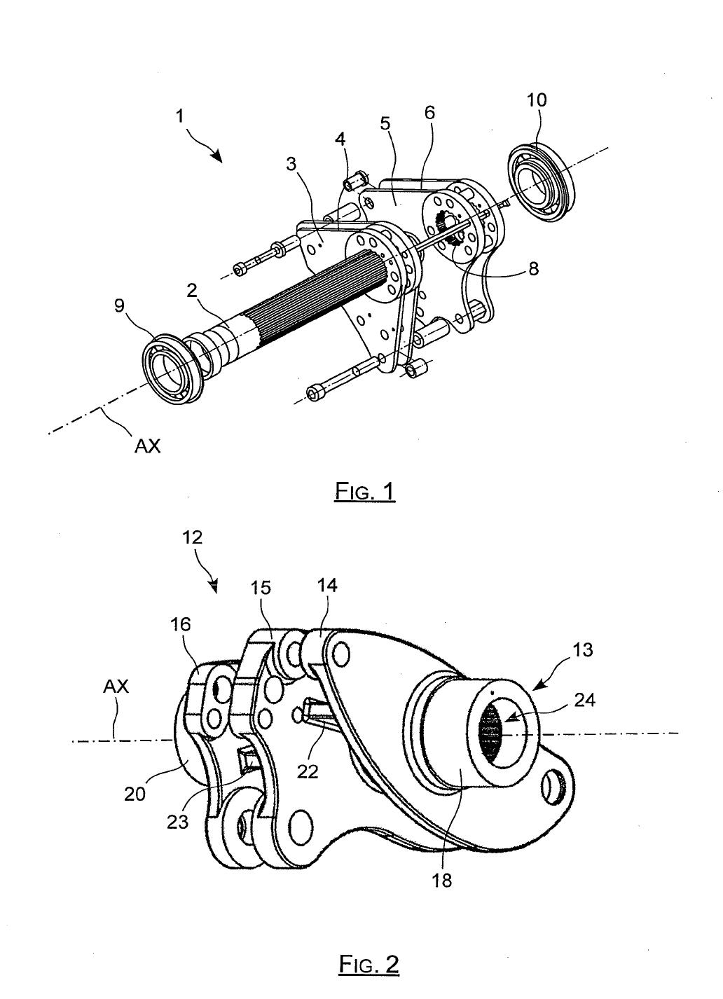

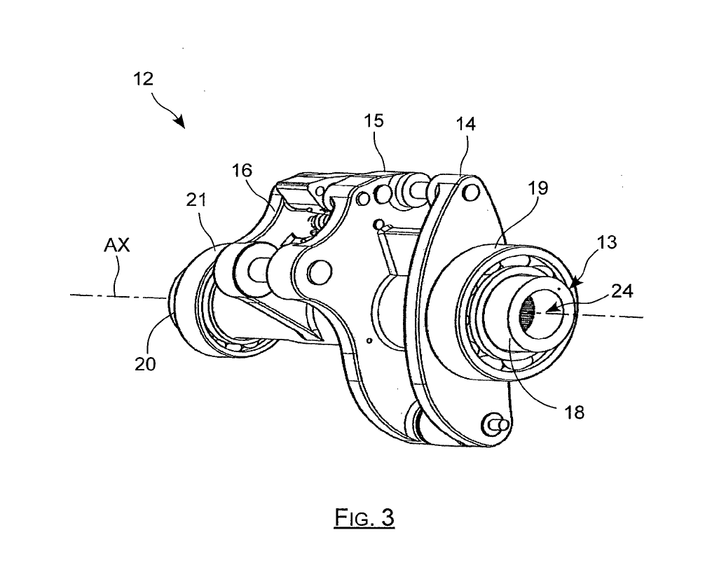

As seen in FIG. 2, the cast part, which is marked as 12, comprises a tubular portion 13 comprising a splined central through hole extending longitudinally to receive a corresponding splined axle, which is not shown on the figures.

This tubular portion 13 carries three levers or cams, marked as 14, 15 and 16, which are integral with this tubular portion 13. As seen in FIG. 2, these three levers 14-16 are spaced apart from each other along a longitudinal axis marked as AX, and which corresponds to the central axis of the tubular portion 13.

Each lever has a flat body extending perpendicular to the longitudinal axis AX, this body surrounding entirely the tubular portion 13 with which it is integral and having one or several extremities extending at a distance from the longitudinal axis AX. These extremities of the levers are connected with other moving parts of the operation mechanism which are not shown on the drawings.

This tubular portion 13 comprises a first extremity 18 which protrudes out of the first lever 14, and which has a cylindrical outer surface to form the seat of a corresponding ball bearing 19 which is visible in FIG. 3. This same tubular portion 13 comprises a second extremity 20, opposite to the first extremity and protruding out of the third lever 16. This second extremity 20 also has a cylindrical outer face to form another seat receiving a second ball bearing 21 shown on FIG. 3.

The cylindrical outer faces of these seats 18, 20 are machined on a lathe to have accurately the appropriate diameters to receive the ball bearings. Thanks to these two seats 18, 20, the whole shaft is carried by the cast part 12 which is carried by the bearings mounted on support elements of the mechanism.

The first lever 14 is linked to the second lever 15 by a wall portion 22 which extends radially and parallel to the longitudinal axis AX, and which is also linked to the outer face of the tubular portion 13. The second lever 15 is linked to the third lever 16 by another wall portion 23 which is also oriented radially and parallel to the longitudinal axis, this other wall portion 23 being also linked to the outer face of the tubular portion 13. Other walls oriented parallel to the longitudinal axis can also be provided to link the levers together with the tubular portion.

The tubular portion 13 with its extremities 18 and 20, the levers 14-16 and the wall portions 22 an 23 both form a single integral cast part which can be made of aluminum.

As already mentioned, the center of the tubular portion 13 comprises a splined through hole 24 to receive the splined axle.

With this structure, the diameter of the tubular portion 13 can be made large so as to have a large moment of inertia in order to provide significant resistance against the torsion stress which results from the high torque applied to the shaft during operation. As a result, the splined axle of the shaft is not subjected to bending, nor to significant torsion, which allows it to be manufactured with metals other than high tensile strength metals and/or be manufacture with reduced diameter.

The wall portions 22, 23 which link the levers to each other significantly improve the mechanical resistance against bending stress which is applied to the shaft during operation, i.e. when it is actuated by the spring for rotation.

In an embodiment of the invention, the torque is transmitted directly from the levers to the splined axle, while it is the cast part which withstands most of the bending and torsion stress since it has a very rigid structure and since it is directly carried by the bearings. Since the general structure of the cast part 12 provides improved mechanical resistance, by virtue of the larger diameter of the tubular part 13 and of the reinforcing walls 22, 23, this cast part can be made of aluminum.

Since all the levers are integral with the cast part, the number of components of the main shaft is significantly reduced, resulting in significant cost savings.

Moreover, coupling the operation mechanism to the actuating lever of the circuit breaker mainly requires to insert the splined axle into the central hole of the cast part, and to couple this splined axle to the actuating member of the circuit breaker.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What we claim is:

1. A shaft for an operating mechanism of a circuit breaker, the shaft comprising a splined axle carrying levers configured to cooperate with other parts of the mechanism, the shaft configured to be carried by ball bearings and to be connected to an actuating member of the circuit breaker to move it, wherein the shaft comprises a cast part comprising the cams and comprising seats for the ball bearings at each of its extremities, the cast part comprising a splined longitudinal through hole at its center to receive the splined axle.

2. The shaft according to claim 1, wherein the cast part comprises a central tubular portion which comprises extremities having cylindrical outer faces to form the seats for the ball bearings.

3. The shaft according to claim 2, wherein the levers comprise a flat body oriented perpendicular to the longitudinal direction of the tubular portion, each flat body surrounding the tubular portion and comprising at least an extremity extending at distance from the tubular portion.

4. The shaft according to claim 1, where the cast part is made of aluminum.

5. A cast part such as defined in claim 1.
